(19) United States
(12) Patent Application Publication
(10) Pub. No.: US 2005/0015264 A1
(43) Pub. Date: Jan. 20, 2005

(54) Methods, systems, and a computer-readable medium for defining and evaluating business rules during runtime of a computer software application program

(75) Inventor: Scott Mutchler, Roanoke, VA (US)

Correspondence Address: MERCHANT & GOULD PC, P.O. BOX 2903, MINNEAPOLIS, MN, 55402-0903, US

(73) Assignee: BellSouth Intellectual Property

(21) Appl. No.: 10/618,830

(22) Filed: Jul. 14, 2003

(51) Int. Cl. G06F 17/60

(52) U.S. Cl. 705/1

(57) ABSTRACT

Methods, systems, and a computer-readable medium are provided for a set of business rules during runtime of a software application program in a computer system. During runtime of a software application, a current rule is specified for a set of business rules. Then, one or more conditions are defined for the current rule. A condition is a decision based on data made available to the software application. Next, one or more actions for each condition are defined for the current rule. Next, each condition is linked with an action to define a business rule. The aforementioned steps are then repeated until the set of business rules have been defined. By defining the business rules during runtime, rules may be defined for a variety of application programs without programming. After the business rules have been defined, they may be.evaluated during runtime of a software application program in a computer system. The business rule is evaluated based on one or more conditions, actions, and user data defined in a state object. After evaluating the business rule, a determination may be made as to the success of the rule. Based on the evaluation, existing user data in the state object may be updated or new user data may be added to the state object based.

### TECHNICAL FIELD

The present invention is related to defining and evaluating business rules. More particularly, the present invention is related to the dynamically defining and evaluating business rules and during a runtime of a computer software program.

### BACKGROUND OF THE INVENTION

Many companies utilize business application software to define business rules for managing workflow processes. Generally, when business application software is executed on a computer system, the business rules utilize data in a company database for performing a specified task. The business rules are initially defined by programming them into the application software. For example, a telecommunications company may utilize business application software written to determine which technicians to dispatch for working on problems with telephone equipment at a customer location. In order to facilitate this determination, business analysts may utilize the application software to access a technical support database and invoke previously defined business rules for determining whether the customer has a technical support contract, the customer's location, and technicians working near the customer's location. Once a technician is located near the customer's location is located, a technician is dispatched.

Often, business application software needs to be modified to reflect changes in a company's database or to add new functionality. As a result, any existing business rules also need to be modified or new business rules need to be added. Business analysts may modify previously defined business rules by simply editing existing data in a table stored in the application software. In current business application software, however, such modifications are limited to predefined changes programmed into the application. Undefined changes or the addition of new functionality require reprogramming the entire application software source code. Furthermore, current business application software is limited in that it is hard-coded for a specific application problem (e.g., identifying technical support personnel to dispatch to a specific geographic area). Thus, a separate application program is required for each specific application problem to be solved.

It is with respect to these considerations and others that the present invention has been made.

### SUMMARY OF THE INVENTION

In accordance with the present invention, the above and other problems are solved by methods, systems, and a computer-readable medium for defining and evaluating a set of business rules during runtime of a software application program in a computer system. By defining the business rules during runtime, rules may be defined for a variety of application programs without programming.

According to one method, during runtime of a software application, a current rule is specified for a set of business rules. Then, one or more conditions are defined for the current rule. A condition is a decision based on data made available to the software application. Next, one or more actions for each condition are defined for the current rule. Next, each condition is linked with an action to define a business rule. The aforementioned steps are then repeated until the set of business rules have been defined.

Prior to specifying a current rule, a rule category may be created for the set of business rules. A state object may also be defined for the current rule. A state object is an area in memory for storing data. A state object may include one or more objects comprising user data relevant to the current rule. For example, the user data may include fields stored in a database. A user action may update the fields in the database during runtime of the software application. After linking the conditions with the actions to define a business rule, the current rule is stored in the rule category for the set of rules. In storing the current rule in the rule category for the set of rules, a data file is generated for the current rule in the rule category. The data file may be an XML file. The data file may be saved as a file on a disk or in a database in a computer system.

The defined conditions may include pattern conditions, structured query language (“SQL”) conditions, and script conditions. A pattern condition is a decision based on one or more fields in one or more data objects. A SQL condition is a decision in which one more fields are used in executing a SQL statement. A script condition is a decision in which a script performs customized operations on the one or more fields in the one or more data objects. The defined actions may include pattern actions, SQL actions, and script actions that include updating data in the one or more data objects within the state object.

According to another method, a business rule is evaluated during runtime of a software application program in a computer system. The method includes retrieving a business rule and evaluating-the business rule based on one or more conditions, actions, and user data defined in a state object. The business rule may be retrieved from a database or a file. After evaluating the business rule, a determination may be made as to the success of the rule. Based on the evaluation, existing user data in the state object may be updated or new user data may be added to the state object based.

In accordance with other aspects, the present invention relates to a system for defining a set of business rules. The system includes a rule designer module. The rule designer module allows a user to specify a current rule for the set of business rules, define a state object for the current rule, define one or more conditions for the current rule, define one or more actions for the current rule, links each condition with each action to define a business rule from the current rule, and generates a data file representing the defined business rule. The system further includes a database for storing the user data for one or more data objects in the state object defined by the rules engine module.

In accordance with other aspects, the present invention relates to a system for evaluating a business. The system includes a rules engine module for retrieving a business rule, evaluating the business rule based on one or more conditions and actions defined for the rule, determining the success or failure of the business rule based on the evaluation, and updating user data in a state object based on the evaluation of the business rules.

Other aspects of the invention may be implemented as a computer process, a computing system, or as an article of manufacture such as a computer program product or computer-readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates a computer network architecture which may be utilized in various embodiments of the invention.

FIG. 2 illustrates a computer system architecture of the client computer illustrated in FIG. 1 according to an embodiment of the invention.

FIG. 3 illustrates logical operations for defining business rules during runtime of the application program illustrated in the computer system architecture of FIG. 2, according to an embodiment of the invention.

FIG. 4 illustrates logical operations for evaluating business rules during runtime of the application program illustrated in the computer system architecture of FIG. 2, according to an embodiment of the invention.

FIG. 5 illustrates a screenshot of a graphical user interface for defining a set of business rules during runtime of the application program illustrated in the computer system architecture of FIG. 2, according to an embodiment of the invention.

FIG. 6 illustrates a Category Name box for entering a rule category name for a rule category created in the graphical user interface of FIG. 5, according to an embodiment of the invention.

FIG. 7 illustrates a Firing Rules box 700 containing a drop down menu 705 for selecting an evaluation method: for the rule category created in the graphical user interface of FIG. 5, according to an embodiment of the invention.

FIG. 8 shows a Rule Name box 800 for selecting a rule name for a current rule in the rule category created in the graphical user interface of FIG. 5, according to an embodiment of the invention.

FIG. 9 illustrates a screenshot of the graphical user interface of FIG. 5 for selecting a state object, according to an embodiment of the invention.

FIG. 10 illustrates an Entities box showing the selection of a data object from the state object selected in FIG. 9, according to an embodiment of the invention

FIG. 11 illustrates a Pattern Condition box for defining a pattern condition for a current rule in the rule category created in the graphical user interface of FIG. 5, according to an embodiment of the invention.

FIG. 12 illustrates a SQL Condition box for defining a SQL condition for a current rule in the rule category created in the graphical user interface of FIG. 5, according to an embodiment of the invention.

FIG. 13 illustrates a Pattern Action box for defining a pattern action for the current rule in the rule category created in the graphical user interface of FIG. 5, according to an embodiment of the invention.

FIG. 14 illustrates a Script box for defining a pattern condition for the current rule in the rule category created in the graphical user interface of FIG. 5, according to an embodiment of the invention.

FIG. 15 illustrates the user interface of FIG. 5 displaying a flow chart representing a defined business rule.

### DETAILED DESCRIPTION OF THE INVENTION

Embodiments of the present invention provide methods, systems, and a computer-readable medium for defining and evaluating business rules during runtime of a software application program in a computer system. In the following detailed description, references are made to the accompanying drawings that form a part hereof, and in which are shown by way of illustration specific embodiments or examples. Referring now to the drawings, in which like numerals represent like elements through the several figures, aspects of the present invention and the exemplary operating environment will be described.

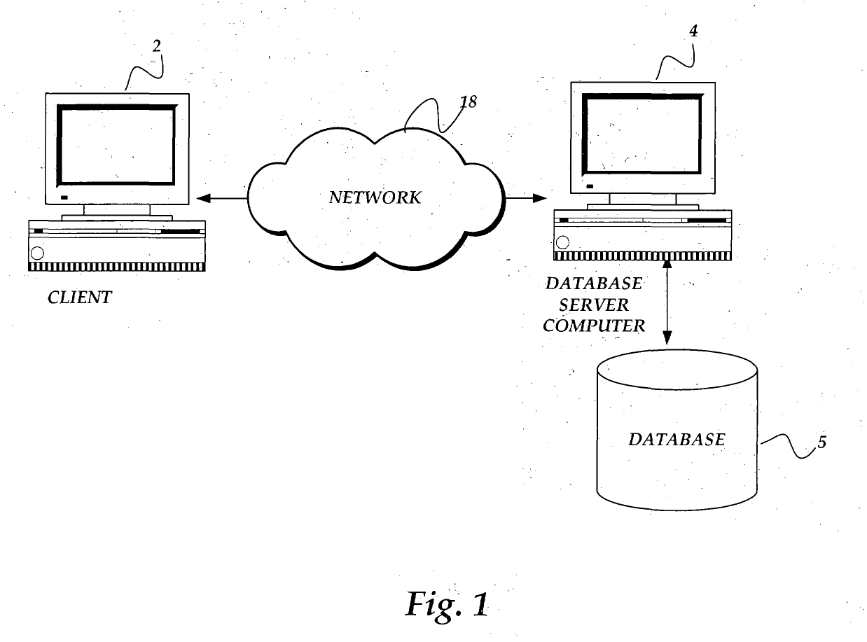

FIG. 1 and the following discussion are intended to provide a brief, general description of a suitable computing environment in which the invention may be implemented. While the invention will be described in the general context of program modules that execute in conjunction with an application program that runs on an operating system on a computer system, those skilled in the art will recognize that the invention may also be implemented in combination with other program modules. Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Turning now to FIG. 1, an illustrative computer network architecture for practicing the various embodiments of the invention will now be described. The computer network includes. a client computer 2 operative to execute one or more application programs. The client computer 2 communicates with a database server computer 4 through the network 18. The database server computer 4 stores a database 5 which may include a collection of data organized into fields, records, and files.

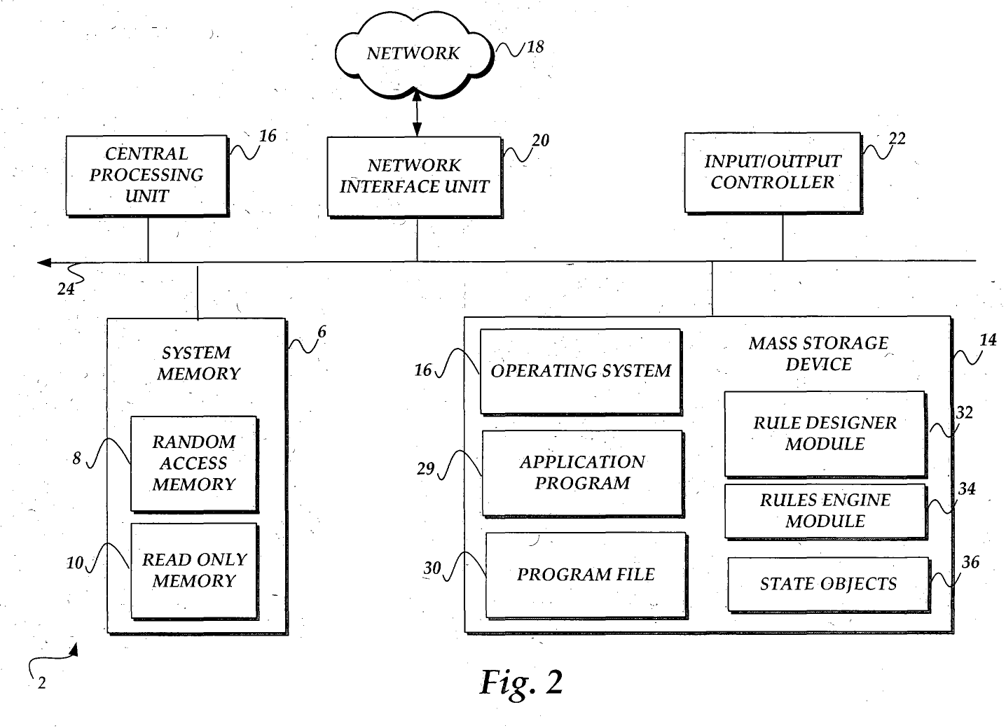

Turning now to FIG. 2, an illustrative computer architecture for the client computer 2 (which was discussed briefly above) for practicing the various embodiments of the invention will be described. The client computer 2 may include a standard personal computer operative to execute one or more application programs, such as application program 29, for invoking a set of business rules. Alternatively, the client computer 2 may include another type of computing device operative to access a network 18, such as a personal digital assistant or other type of computer. The client computer 2 includes a central processing unit 4 (“CPU”), a system memory 6, including a random access memory 8 (“RAM”) and a read-only memory (“ROM”) 10, and a system bus 13 that couples the system memory 6 to the CPU 4.

The client computer 2 further includes a mass storage device 14 for storing an operating system 16, the application program 29, a program file 30, a rule designer module 32 for designing business rules, a rules engine module 34 for evaluating business rules, and state object 36 for storing user data relevant to business rules. The application program 29 calls on the rules engine module 34 for evaluating business rules. In one embodiment, the application program 29, the rule designer module 32, and the rules engine module 34 are Java program files which may support dynamic binding. As is known to those skilled in the art, dynamic binding (also known as reflection) allows the invocation of a method and the reading of attributes from the name of the method.

The rule designer module 32 enables a user to define conditions and actions which the rule designer module 32 links together to define business rules for achieving a desired result. Those skilled in the art will appreciate that the linking may be achieved via a Java chainable interface. A condition is a decision based on data made available to the software application, such as data in the state object 80 which contains a subset of the data in the database 5. Next, one or more actions for each condition are defined for the current rule. Several types of conditions and actions may be defined for each business rule defined by the rule designer module 32. The different types of conditions and actions which may be defined by the rule designer module 32 will be discussed in greater detail below.

The rule designer module 32 interacts with a state objects 36 which may contain user data stored in data objects. The user data may be a subset of the data from the database 5. The rule designer module 32 may retrieve the user data from the database server computer 4 over the network 18 an insert it into a state object 36. In one embodiment, the state object 36 may be implemented as a Java HashMap class extension. As is known to those skilled in the art, a Java HashMap allows entities such as data objects to be inserted and removed by a key or entity name.

A user may use the rule designer module 32 to define several types of conditions and actions for each business rule. In one embodiment, the conditions which may be defined include a pattern condition, a structured query language (“SQL”) condition, and a script condition. A pattern condition allows a user to evaluate one or more fields of data in one or more data objects. The value of the each field may then be compared to a specific value, pattern, or another field. Pattern conditions use Java dynamic binding or reflection to evaluate one or more data objects. If the field values of the object match the pattern, the condition is satisfied. A pattern action updates or creates a single data object in a state object. Like pattern conditions, pattern actions use dynamic binding or reflection to allow one or more fields to be updated on an existing data object, a clone of an existing data object, or a new data object

A SQL condition allows a user to use values stored in one or more fields of data in one or more data objects to execute a SQL statement. As is well known to those skilled in the art, SQL is a standardized query language for requesting information from a database. In one embodiment, the SQL statements may be either select statements or stored procedure calls using Java Database Connectivity (“JDBC”). As is known to those skilled in the art, JDBC is a Java Application Program Interface (“API”) that enables Java programs to execute SQL statements. JDBC allows Java programs to interact with any SQL-compliant database. A SQL action allows for the execution of a SQL statement against a database (i.e., insert, update, delete, stored procedure call) using data object field values as parameters. SQL actions may also execute an SQL select or stored procedure query using data object field values as parameters. The results of the query may be used to update a single data object in a similar fashion to a pattern action.

A script condition allows a user to write a JavaScript script which allows a user to perform various operations including examining the data objects in a state object, executing database queries using JDBC, and invoking methods on other Java objects.

Script conditions will return a Boolean “true” value if the condition is satisfied. A script action is similar to a script condition without returning a Boolean value.

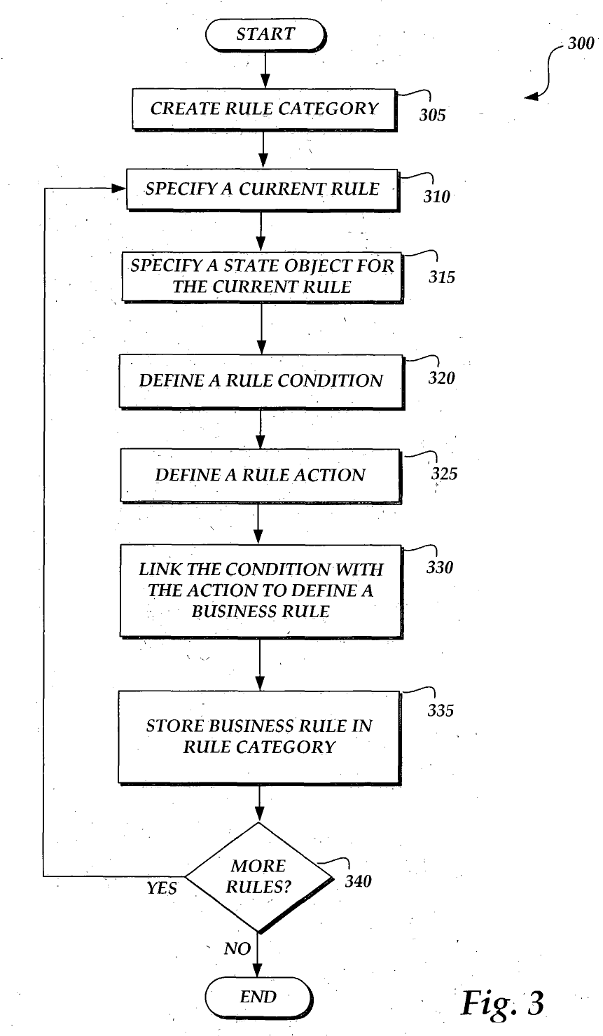

Once a set of business rules have been defined in the rule designer module 32, the rule designer module 32 may serialize (i.e., convert the business rules to a data stream of byte values) them for storage as the program file 30. In one embodiment, the program file 30 may be an Extensible Markup Language (“XML”) file for storage. In this embodiment, the program file 30 may be stored in a relational database or on a disk as a number of files. The operation of the rule designer module 34 will be described in greater detail below in the description of FIG. 3.

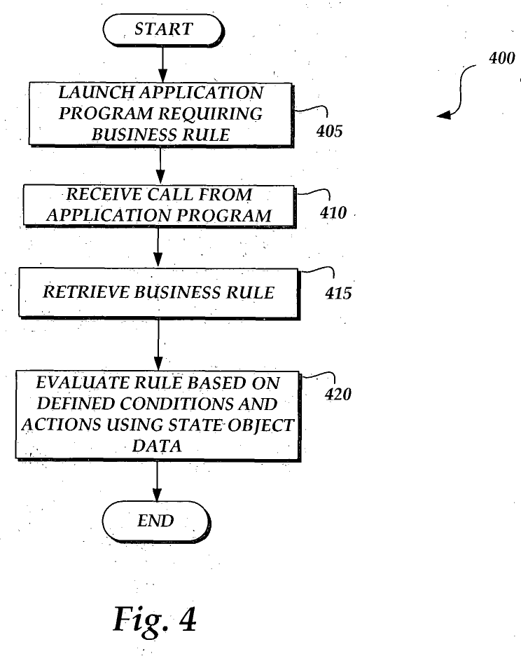

The rules engine module 34 evaluates the business rules defined in the rule designer module 32. The rules engine module 34 retrieves a saved business rule (or category of business rules) from storage and evaluates the conditions and actions defined therein. The operation of the rules engine module 34 will be described in greater detail below in the description of FIG. 4.

The mass storage device 14 is connected to the CPU 4 through a mass storage controller (not shown) connected to the bus 13. The mass storage device 14 and its associated computer-readable media, provide non-volatile storage for the client computer 2. Although the description of computer-readable media contained herein refers to a mass storage device, such as a hard disk or CD-ROM drive, it should be appreciated by those skilled in the art that computer-readable media can be any available media that can be accessed by the client computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the client computer 2 may operate in a networked environment using logical connections to remote computers, such as the database server computer 4 (as shown in FIG. 1), through the network 18. The client computer 2 may connect to the network 18 through a network interface unit 20 connected to the bus 13. It should be appreciated that the network interface unit 20 may also be utilized to connect to other types of networks and remote computer systems. The client computer 2 may also include an input/output controller 22 for receiving and processing input from a number of devices, including a keyboard, mouse, or electronic stylus (not shown in FIG. 1). Similarly, an input/output controller 22 may provide output to a display screen, a printer, or other type of output device.

FIGS. 3-4 illustrate logical operations for defining (FIG. 3) and evaluating (FIG. 4) business rules in the computer system architecture of FIG. 2, according to an embodiment of the invention. The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

Turning now to FIG. 3, the logical operations 300 begin at operation 305 where a user utilizes the rule designer module 32 to create a rule category for a set of business rules. Rule categories allow rules to be grouped so that a series of rules may be evaluated on a given state object subject to one or more evaluation methods. In one embodiment, the evaluation method may be a “fire all” method in which each rule in the rule category is executed regardless of whether any of the rules fails. In an alternative embodiment, the evaluation method may be a “fire until first failure” method in which each rule in the rule category is executed until one rule fails. In yet another alternative embodiment, the evaluation method may be a “fire until first success” method in which each rule in the rule category is executed until one is successful.

The logical operations 300 continue from operation 305 to operation 310 where a user specifies a current rule for the rule category. At operation 315, user defines a state object for the current rule in the rule designer module 32. As discussed above, a state object contains a subset of database data in one or more data objects. These data objects are evaluated by conditions and acted on by actions defined in the rule designer module 32. At operation 320, a user defines one or more rule conditions for the current rule in the rule designer module 32. As discussed above, the rule conditions may be a pattern condition, a SQL condition, or a script condition. At operation 325, a user defines one or more rule actions in the rule designer module 32, based on the previously defined conditions, for the. current rule. As discussed above, the rule actions may be a pattern action, a SQL action, or a script action.

The logical operations 300 continue from operation 325 to operation 330 where the rule designer module 32 links the one or more defined conditions with the one or more defined actions to define a business rule. At operation 335, the rule designer module 32 stores the newly defined business rule in the rule category. At operation 340, if a user determines that more business rules need to be defined for the rule category, the logical operations 300 then return to operation 310 where a new current rule is specified. If, at operation 340, a user determines .that no more business rules need to be defined for the rule category, the logical operations then end. As discussed above, after defining a set of business rules, the rule designer module 32 converts the rules into a data stream of byte values for storage as a file or in a database.

FIG. 4 illustrates logical operations 400 for evaluating business rules in the computer system architecture of FIG. 2, according to an embodiment of the invention. The logical operations 400 begin at operation 405 where a user launches the application program 29 and requests an action that requires a business rule (or category of business rules). At operation 410, the application program 29 invokes the business rule by calling the rules engine module 34. At operation 415, the rules engine module 34 retrieves the business rule (or category of business rules) from a storage location by the name specified for the rule or rule category in the rule designer module 32. As discussed above in FIGS. 2-3, the business rule may be stored as an XML file on a disk in a computer system or in a database.

At operation 420, after retrieving the business rule (or category of business rules), the rules engine 34 evaluates each rule based on the conditions and actions defined for the rule by the user in the rule designer module 32 using the user data in the state object 36. As discussed above, each rule may contain one or more pattern conditions and actions, SQL conditions and actions, and script conditions and actions. At operation 425, the rules engine 34.will return a successor failure message to the application program 29 based on the evaluation made at operation 420. As a result of the evaluation, the rules engine 34 may also update existing data or add new data to the state object 36. Following the logical operation 420, the logical operations 400 then end.

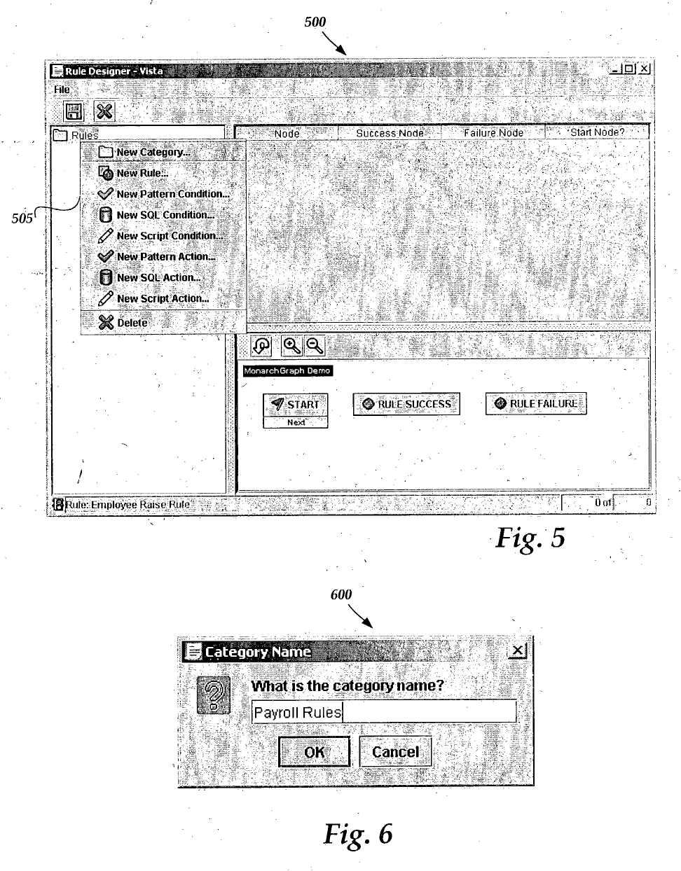

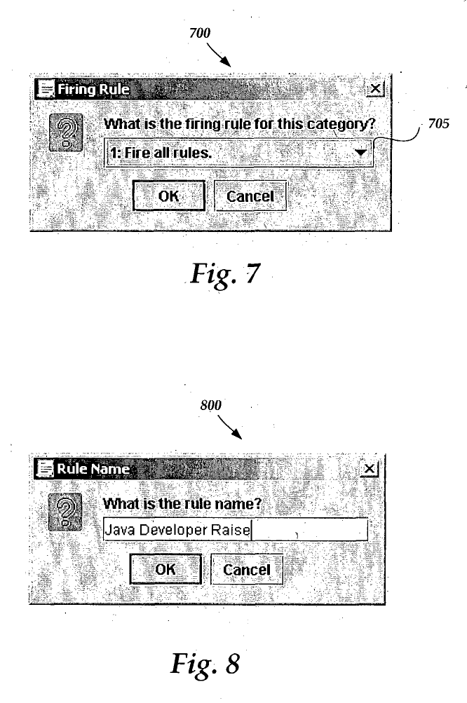

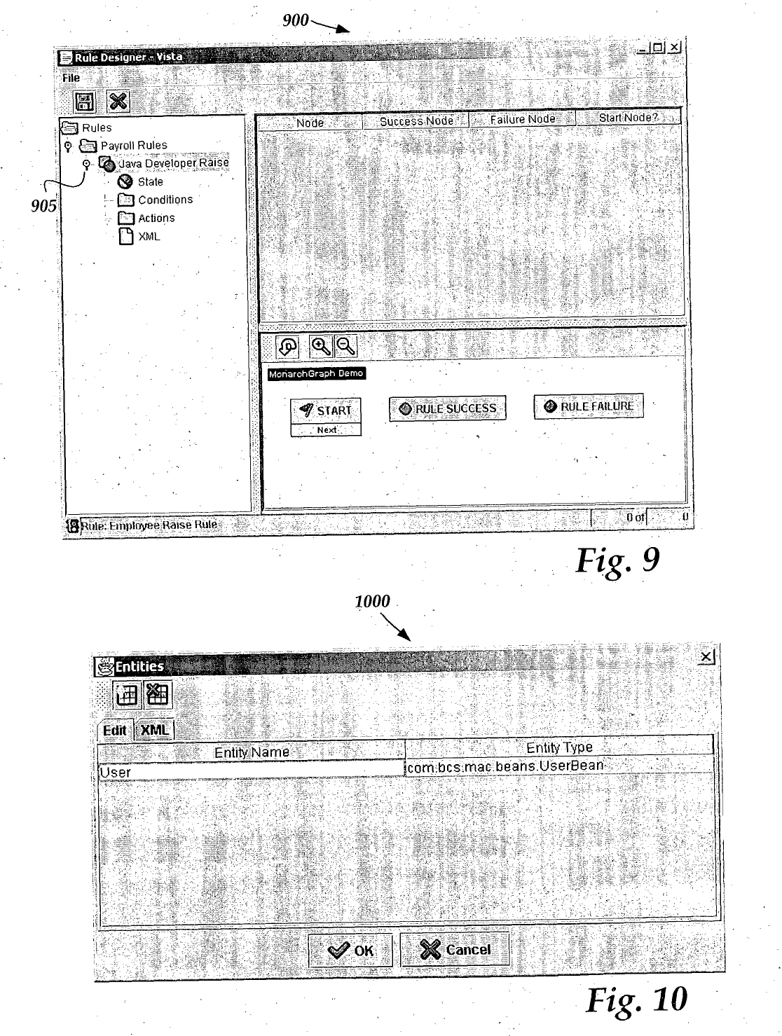

FIGS. 5-15 show illustrative screenshots of a user interface 500 that is utilized by the rule designer module 32 for allowing a user to define a set of business rules for modifying a company's personnel records. As shown in FIG. 5, the screenshot includes a drop down menu 505 for creating a rule category for the business rules. FIG. 6 shows a Category Name box 600 for entering a rule category name for the rule category. FIG. 7 shows a Rule Firing box 700 containing a drop down menu 705 for selecting an evaluation method for the rules in the rule category. FIG. 8 shows a Rule Name box 800 for selecting a rule name for the current rule in the rule category. FIG. 9 illustrates another screenshot of the user interface 500 which shows a pane 905 showing a tree view of the rule category (Payroll Rules) and the rule name (Java Developer Raise) as well as a State object. FIG. 10 illustrates an Entities box 1000 which shows that a data object (User) has been selected from the State object. The business rules will be evaluated against the data object “User” when the rules are executed.

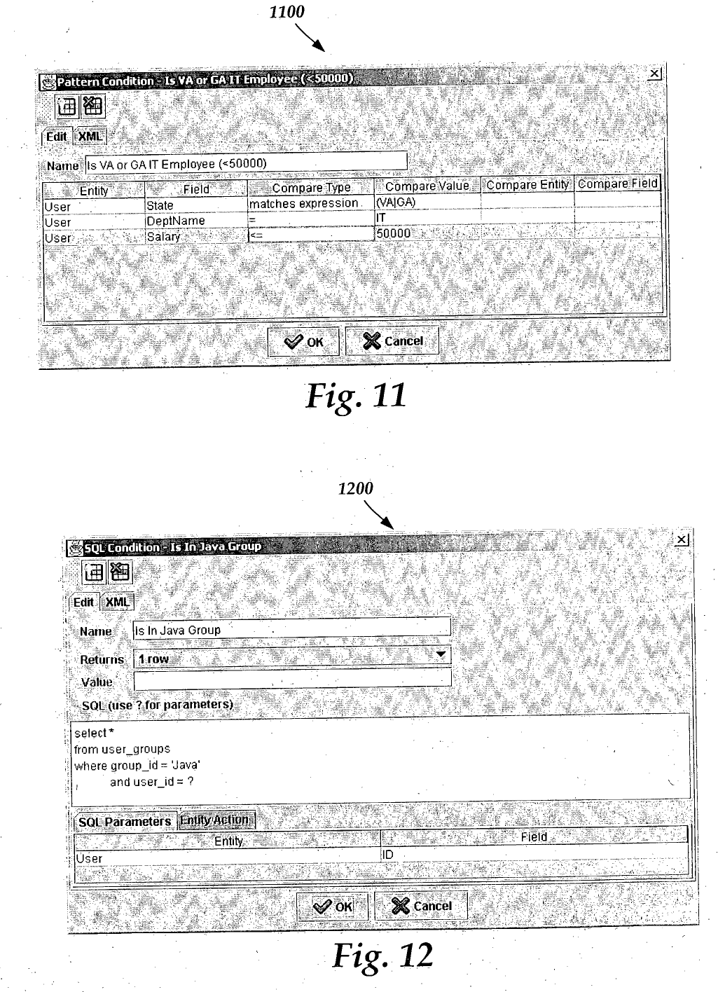

FIG. 11 illustrates a Pattern Condition box 1100 for defining a pattern condition for the business rule. As shown in FIG. 11, the pattern condition includes evaluating the values for the fields “State,” “DeptName,” and “Salary” the result of which is the identity of IT Employees in Georgia (GA) or Virginia (VA) earning less than $50,000. FIG. 12 illustrates an SQL Condition box 1200 for defining a SQL condition for the business rule. As shown in FIG. 12, the SQL condition includes a query for determining Georgia and Virginia employees who are in the Java Group.

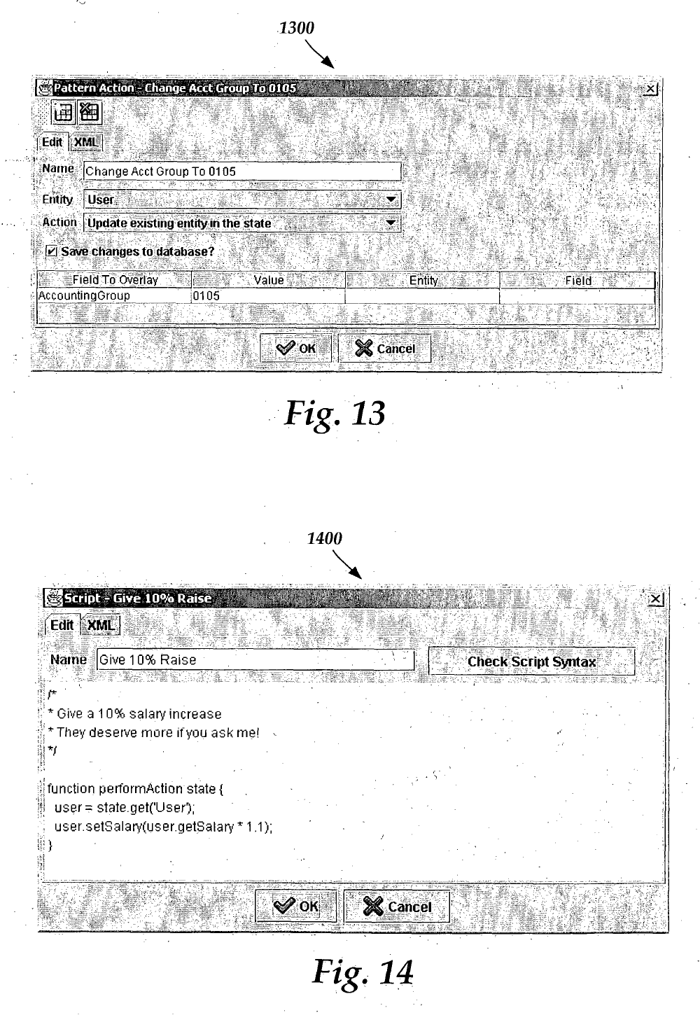

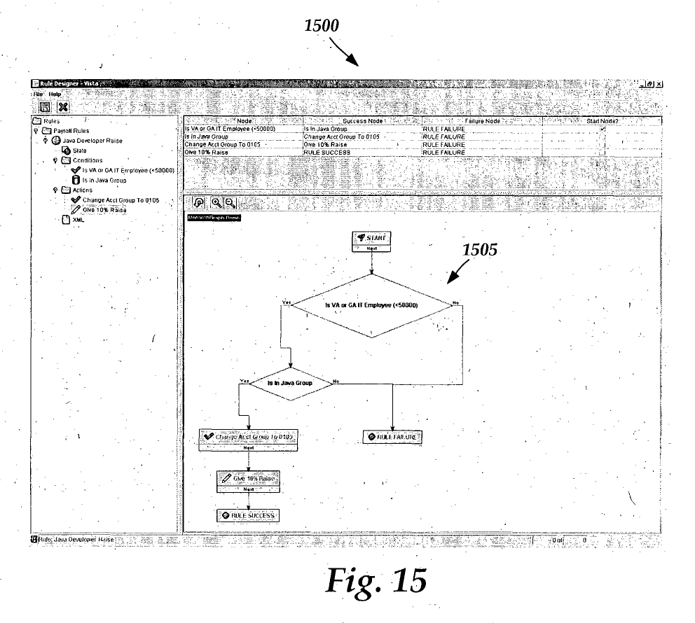

FIG. 13 illustrates a Pattern Action box 1300 for defining a pattern action for the business rule. As shown in FIG. 13, the pattern action is defined to update the data object “User” by creating new accounting group for the. Georgia and Virginia employees who are in the Java Group and who earn less than $50,000. FIG. 14 illustrates a Script box 1400 for defining a script action for the business rule. As shown in FIG. 13, the script action is defined to give a 10% salary increase to the Georgia and Virginia Java employees in the newly created accounting group. FIG. 15 illustrates the user interface 500 which displays a flow chart 1505 created by the application program 29 once the business rule has been defined.

Once the “Java Developer Raise” business rule described in FIGS. 5-15 above has been defined, the application program 29 may invoke the rule by calling the rules engine module 34 to evaluate the rule by following the conditions and actions defined for the rule based on a list of employees in the User object. For example, a user may launch the application program 29 to determine Java developers in Georgia and Virginia who earn less than $50,000 and to give them a raise. The application program 29 may then call the rules engine module 34 which retrieves the “Java Developer Raise” business rule from a file or database. The rules engine module 34 may then follow each condition defined in the business rule against the data in the User object. Then for each employee in the User object meeting the defined conditions (i.e., Georgia and Virginia employees in the Java Group earning less than $50,000), the rules engine module will follow the defined actions (i.e., creating a new accounting group for the employees and giving each employee a 10% salary increase).

It will be appreciated that the embodiments of the invention described above enable the definition and evaluation of business rules during runtime of a software application program. Previously, business rules could only be defined by programming them into a software application and then were further limited in that they could only be defined for a specific application. Embodiments of the invention provide a rule designer module and a rules engine module which enable business rules to be defined and evaluated during runtime of a software application using a Java process known as dynamic binding. In this manner, business rules may be defined without programming.

Although the invention has been described in language specific to computer structural features, methodological acts and by computer readable media, it is to be understood that the invention defined in the appended claims is not necessarily limited to the specific structures, acts or media described. Therefore, the specific structural features, acts and mediums are disclosed as exemplary embodiments implementing the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of defining a set of business rules during runtime of a software application program in a computer system, the method comprising:
during runtime of the software application program,
(a) specifying a current rule for the set of business rules;
(b) defining at least one condition for the current rule;
(c) defining at least one action for the current rule, wherein the at least one action is based on the at least one condition;
(d) linking the at least one condition with the at least one action to define a business rule from the current rule; and
(e) repeating operations (a)-(d) until each business rule in the set of business rules has been defined.

2. The method of claim 1, further comprising:
prior to specifying a current rule, creating a rule category for the set of business rules;
defining a state object for the current rule, wherein the state object comprises user data relevant to the current rule; and
after linking the at least one condition with the at least one action to define a business rule from the current rule, storing the current rule in the rule category for the set of rules.

3. The method of claim 2, wherein the user data comprises fields stored in a database.

4. The method of claim 3, wherein the at least one user action updates the fields in the database during runtime of the software application.

5. The method of claim 2, wherein storing the current rule in the rule category for the set of rules comprises:
generating a data file for the current rule in the rule category;
saving the data file in the computer system.

6. The method of claim 5, wherein saving the data file in the computer system comprises saving the data file to the database.

7. The method of claim 5, wherein the data file is an XML file.

8. The method of claim 1, wherein the at least one condition is a pattern condition.

9. The method of claim 1, wherein the at least one condition is a structured query language (SQL) condition.

10. The method of claim 1, wherein the at least one condition is a script condition.

11. The method of claim 1, wherein the at least one action is a pattern action.

12. The method of claim 1, wherein the at least one action is a structured query language (SQL) action.

13. The method of claim 1, wherein the at least one action is a script action.

14. A method of evaluating a business rule during runtime of a software application program in a computer system, the method comprising:
during runtime of the software application,
retrieving a business rule, wherein the business rule comprises at least one defined condition and at least one defined action; and
evaluating the business rule based on the at least one defined condition, the at least one defined action, and user data in a state object.

15. The method of claim 14, further comprising determining success of the business rule based on the evaluation.

16. The method of claim 14, further comprising updating existing user data in the state object based on the evaluation of the business rules.

17. The method of claim 14, further comprising adding new user data to the state object based on the evaluation of the business rules.

18. The method of claim 14, wherein the business rule is retrieved from a database.

19. The method of claim 14, wherein the business rule is retrieved from a file.

20. The method of claim 14; wherein the at least one condition comprises at least one of a pattern condition, structured query language (SQL) condition, and a script condition.

21. The method of claim 14, wherein the at least one action comprises at least one of a pattern action, a structured query language (SQL) action, and a script action.

22. A computer-readable medium having computer executable modules for defining and executing a set of business rules comprising:
a rule designer module for:
creating a rule category for the set of business rules;
(a) specifying a current rule for the set of business rules;
(b) defining at least one condition for the current rule;
(c) defining at least one action for the current rule, wherein the at least one action is based on the at least one condition;
(d) linking the at least one condition with the at least one action to define a business rule from the current rule;
(e) generating a data file representing the defined business rule; and
(f) repeating operations (a)-(e) for each business rule in the rule category; and
storing a data file generated for each defined business rule in the rule category; and
a rules engine module for evaluating each business rule in the rule category.

23. The computer-readable medium of claim 22, wherein the user data comprises fields stored in a database.

24. The computer-readable medium of claim 22, wherein the rules engine module evaluates each business rule based on the at least one condition and the at least one action.

25. The computer-readable medium of claim 22, wherein the at least one condition is a pattern condition.

26. The computer-readable medium of claim 22, wherein the at least one condition is a structured query language (SQL) condition.

27. The computer-readable medium of claim 22, wherein the at least one condition is a script condition.

28. The computer-readable medium of claim 22, wherein the at least one action is a pattern action.

29. The computer-readable medium of claim 22, wherein the pattern action uses dynamic binding.

30. The computer-readable medium of claim 22, wherein the at least one action is a structured query language (SQL) action.

31. The computer-readable medium of claim 22, wherein the at least one action is a script action.

32. A system for defining a set of business rules comprising:
a rule designer module for:
creating a rule category for the set of business rules;
(a) specifying a current rule for the set of business rules;
(b) defining a state object for the current rule, wherein the state object comprises one or more data objects, each data object containing user data relevant to the current rule;
(c) defining at least one condition for the current rule;
(d) defining at least one action for the current rule, wherein the at least one action is based on the at least one condition;
(e) linking the at least one condition with the at least one action to define a business rule from the current rule;
(f) generating a data file representing the defined business rule; and
(g) repeating operations (a)-(f) for each business rule in the rule category; and
a database for storing the user data for in the state object defined by the rules engine module;

33. A computer system for evaluating a business rule comprising:
a rules engine module for:
retrieving a business rule, wherein the business rule comprises at least one defined condition and at least one defined action;
evaluating the business rule based on the at least one defined condition and the at least one defined action;
determining the success or failure of the business rule based on the evaluation; and
updating user data in a state object based on the evaluation of the business rules.

34. The computer system of claim 33, wherein the rules engine module adds new data to the state object based on the evaluation of the business rules.

35. The computer system of claim 33, wherein the at least one condition comprises at least one of a pattern condition, structured query language (SQL) condition, and a script condition.

36. The computer system of claim 33, wherein the at least one action comprises at least one of a pattern action, a structured query language (SQL) action, and a script action.
